(19) United States
(12) Patent Application Publication
(10) Pub. No.: US 2001/0014869 A1
(43) Pub. Date: Aug. 16, 2001

(54) Information processing apparatus, storage medium provided therewith, and information processing method

(76) Inventor: Katsumi Yoshizawa, Tokyo (JP)

Correspondence Address: FROMMER LAWRENCE & HAUG, 745 FIFTH AVENUE, NEW YORK, NY, 10151, US

(21) Appl. No.: 09/727,633

(22) Filed: Dec. 1, 2000

(30) Foreign Application Priority Data
Dec. 3, 1999 (JP) 11-344393

(51) Int. Cl. G06F 17/60

(52) U.S. Cl. 705/14; 705/50

(57) ABSTRACT

An information processing apparatus processes information concerning electronic commerce in which a customer receiving services offered by a service provider obtains points in accordance with the amount of money having been paid to the service provider. The information processing apparatus includes a first communication controlling device for controlling data communication with another information processing apparatus via a first network, a first recording device for recording information on a plurality of the service providers and information on a plurality of the customers receiving services from the plurality of service providers, a second communication controlling device for controlling data communication with a financial institution information processing apparatus via a second network, a payment computing device for computing an amount of money to be refunded to the customer in accordance with the number of the points the customer owns, and a signal generating device for generating a signal that requests the financial institution information processing apparatus having an account of the customer to transfer a predetermined amount of money to the account of the customer.

### BACKGROUND OF THE INVENTION

1. Field of the Invention

The present invention relates to information processing apparatuses, storage media provided therewith, and information processing methods. More particularly the present invention relates to an information processing apparatus, a storage medium provided therewith, and an information processing method which enable the following online redemption service to be safely and securely realized in electronic commerce via a network. That is, by controlling communication with financial institutions via the network, this online redemption service computes an amount of money to be redeemed by a customer based on the points corresponding to the amount of money the customer has paid to service providers and reports the computed amount of money to the customer. In addition, a control signal is sent to a corresponding financial institution via a financial network so that the desired amount of money to be redeemed by the customer is transferred from a predetermined account to the customer's account.

2. Description of the Related Art

In electronic commerce on the Internet such as online shopping, when a customer purchases a product from an online store, the following system is offered to the customer in the same manner as offered in actual stores. That is, the online store issues to the customer points corresponding to the amount of money the customer pays for the product, and the customer collects the issued points. The system offers, for example, a service in which the customer receives discounts in a future transaction in accordance with the collected points.

Such a conventional system, which controls the issuing and redemption of points, is not connected to a financial network. Accordingly, services offered by the system to the customer are limited to those which are provided during a direct transaction between the online store and the customer, such as the above-described discount in the future transaction at this online store. Therefore, the conventional system does not offer a variety of services to the customer. Furthermore, in this type of electronic commerce, the issuing and redemption of points is valid exclusively in each online store, and the points cannot be shared and handled among a plurality of different online stores.

### SUMMARY OF THE INVENTION

Accordingly, it is an object of the present invention to provide an information processing apparatus, a storage medium provided therewith, an information processing method which enable the realization of the following safe and secure online redemption service in electronic commerce. That is, by controlling communication with financial institutions via a network, the service computes an amount of money to be redeemed by a customer based on points corresponding to the amount of money the customer has paid to service providers and reports the computed amount of money to the customer. In addition, a control signal is sent to a corresponding financial institution via a financial network so that the desired amount of money to be redeemed by the customer is transferred from a predetermined account to the customer's account.

To this end, according to a first aspect of the present invention, there is provided an information processing apparatus for processing information concerning electronic commerce in which a customer receiving services offered by a service provider obtains points in accordance with the amount of money having been paid to the service provider. The information processing apparatus includes a first communication controlling device for controlling data communication with another information processing apparatus via a first network, a first recording device for recording information on a plurality of the service providers and information on a plurality of the customers receiving services from the plurality of service providers, a second communication controlling device for controlling data communication with a financial institution information processing apparatus via a second network, a payment computing device for computing an amount of money to be refunded to the customer in accordance with the number of the points the customer owns, and a signal generating device for generating a signal that requests the financial institution information processing apparatus having an account of the customer to transfer a predetermined amount of money to the account of the customer. In the apparatus, the first communication controlling device controls communication in which a signal corresponding to the amount of money computed by the payment computing device is sent to an information processing apparatus owned by the customer and a signal corresponding to a desired amount of transfer money is received from the information processing apparatus owned by the customer, and the second communication controlling device controls communication in which the signal generated by the signal generating device is sent to the financial institution information processing apparatus and a signal representing completion of processing by the financial institution information processing apparatus is received.

According to a second aspect of the present invention, an information processing method processes information concerning electronic commerce in which a customer receiving services offered by a service provider obtains points in accordance with the amount of money having been paid to the service provider. The information processing method includes a first communication controlling step for controlling data communication with another information processing apparatus via a first network, a recording step for recording information on a plurality of the service providers and information on a plurality of the customers receiving services from the plurality of service providers, a second communication controlling step for controlling data communication with a financial institution information processing apparatus via a second network, a payment computing step for computing an amount of money redeeming by the customer in accordance with the number of the points the customer owns and a signal generating step for generating a signal that requests the financial institution information processing apparatus having an account of the customer to transfer a predetermined amount of money to the account of the customer. In the method, the first communication controlling step controls communication in which a signal corresponding to the amount of money computed in the payment computing step is sent to an information processing apparatus owned by the customer and a signal corresponding to a desired amount of transfer money is received from the information processing apparatus owned by the customer, and the second communication controlling step controls communication in which the signal generated in the signal generating step is sent to the financial institution information processing apparatus and a signal representing completion of processing in the financial institution information processing apparatus is received.

According to a third aspect of the present invention, a point redemption system redeems points owned by a customer for money. The point redemption system includes a receiving device for receiving a point redemption request for redeeming points owned by the customer for money. The point redemption request includes information on the number of points which is desired to be redeemed for money from among the total points owned by the customer, a transferring device for transferring, to an account of the customer, an amount of money corresponding to the desired number of points in the information included in the point redemption request from among the total points, and an updating device for updating the total points corresponding to the customer by subtracting the desired number of points in the information included in the point redemption request from the total points owned by the customer.

Further objects, features and advantages of the present invention will become apparent from the following description of the preferred embodiments with reference to the attached drawings.

### BRIEF DESCRIPTION OF THE DRAWINGS

FIG. 1 is a block diagram showing an example construction of an overall system which is connected to an open network and a financial network;

FIG. 2 is a block diagram showing the construction of a customer terminal;

FIG. 3 is a block diagram showing the construction of a service provider terminal;

FIG. 4 is a block diagram showing the construction of a point redemption system;

FIG. 5 is a block diagram showing the construction of a point issuing system;

FIG. 6 is a flowchart illustrating processing for issuing an common point ID;

FIG. 7 is a diagram showing a certificate issued by a user certificate system;

FIG. 8 is a diagram illustrating doubly encrypted data;

FIG. 9 is a flowchart illustrating processing for accounting while a service is provided;

FIGS. 10A and 10B are diagrams showing example tables constructed in the point account database;

FIG. 11 is a flowchart illustrating processing for confirming an amount of money to be transferred;

FIG. 12 is a flowchart illustrating point transfer processing;

FIG. 13 is a diagram showing an example table constructed in the point account database; and

FIG. 14 is a diagram showing an example table constructed in an electronic account book database.

### DESCRIPTION OF THE PREFERRED EMBODIMENTS

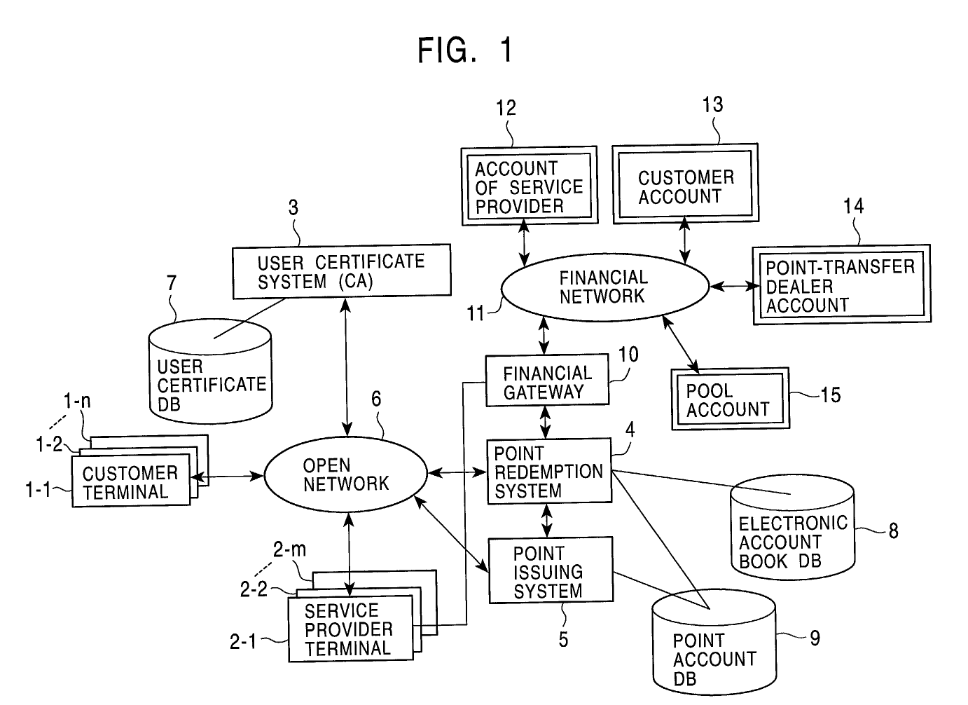

FIG. 1 shows the construction of a system obtained by using the present invention. Basically, the system includes an open network 6, such as the Internet, a financial network 11, and terminals connected thereto. When a customer accesses this system using one of customer terminals 1-1 to 1-n, services, such as utilization of an online-shopping mall, participation in an online game, participation in an online study, and viewing of pay content, are available to the customer. When a service is provided to the customer from a service provider, the customer collects a predetermined number of points corresponding to the amount of money charged by the service provider. This allows the customer to obtain an online redemption in accordance with the cumulative sum of the collected points.

The n customer terminals 1-1 to 1-n, m service provider terminals 2-1 to 2-m, a user certificate system 3, a point redemption system 4, and a point issuing system 5 are connected to the open network 6. The user certificate system 3 is a so-called “CA” (Certificate Authority). The CA is an organization that serves to issue a certificate to authenticate a data sender as a certified group using a user certificate DB (database) 7 when data are exchanged mainly on the network. Hereinafter, as long as there is no need to distinguish the customers' terminals 1-1 to 1-n and the service providers' terminals 2-1 to 2-m individually, the customer terminals 1-1 to 1-n are simply referred to as a customer terminal 1 and the service provider terminals 2-1 to 2-m are simply referred to as a service provider terminal 2.

Other than a dedicated-purpose terminal, a device having a communication facility such as a personal computer, a workstation, and a game console can be used as the customer terminal 1 and the service provider terminal 2. These terminals have functions of creating encryption keys and of making digital signature (i.e., encryption by means of their own encryption keys).

The point redemption system 4 can access an electronic account book DB 8 and a point account DB 9, and the point issuing system 5 can access the point account DB 9. These point redemption system 4 and point issuing system 5 are interconnected and each have a feature of generating an encryption key. The point account DB 9 has, for example, a table for managing each customer's points, a financial institution with which each service provider deals, an account number of each service provider at its financial institution, and the like. The electronic account book DB 8 has history data such as when and how many points are redeemed by which customer. A point transfer dealer manages the point redemption system 4, the point issuing system 5, the electronic account book DB 8, and the point account DB 9. Although, in the present embodiment, the electronic account book DB 8 and the point account DB 9 are independent of the point redemption system 4 and the point issuing system 5, they may be contained in the point redemption system 4 or the point issuing system 5.

The point redemption system 4 is connected via a financial gateway 10 to the financial network 11. The financial network 11 is connected to servers of financial institutions with which each of the customer, the service provider and the point transfer dealer deals. The service provider has an account at a financial institution 12, the customer has an account at a financial institution 13, and the point transfer dealer has an account at a financial institution 14. A pool account is provided at a financial institution 15 for temporarily storing money to be transferred to the customer account during point transfer. Although these financial institutions 12 to 15 are different in the present embodiment, at least some of them may be the same.

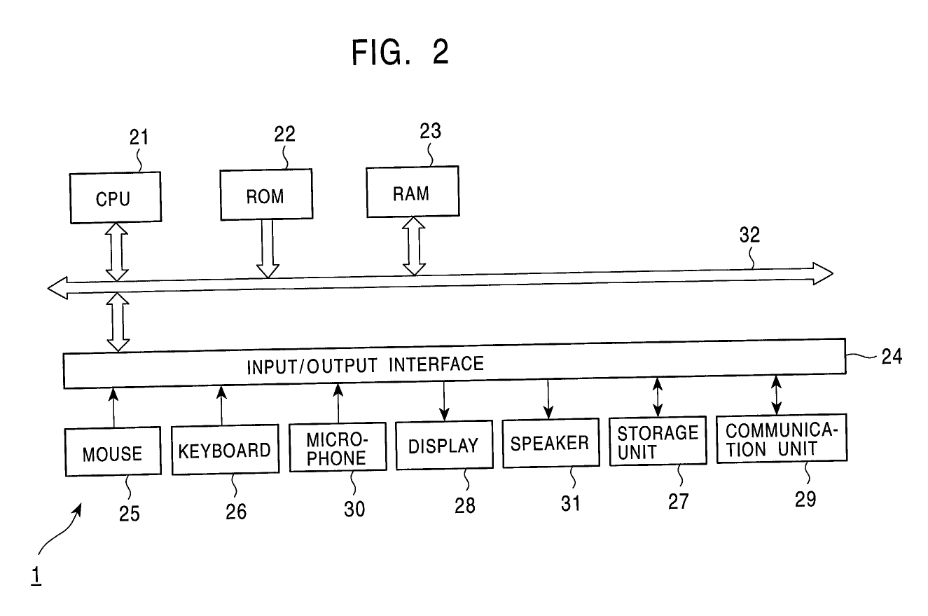

FIG. 2 shows a detailed construction of the customer terminal 1.

A CPU (Central Processing Unit) 21 of the customer terminal 1 performs a variety of processing in accordance with a program stored in a ROM (Read Only Memory) 22 or a storage unit 27. A RAM (Random Access Memory) 23 stores data and programs required for a variety of processing. An input/output interface 24 inputs to the CPU 21 a signal corresponding to an input from an input device such as a keyboard 26 and a mouse 25. In addition, the input/output interface 24 is connected to the storage unit 27, which includes a hard disk and an external storage device, in which the data or the programs are appropriately stored and read.

The input/output interface 24 is connected to a display 28 and a communication unit 29 in which communication can be performed with other devices using electromagnetic waves, visible light, or infrared light. In addition, the input/output interface 24 is connected to a microphone 30 for obtaining audio signals and a speaker 31 for producing sound. An internal bus 32 allows the microphone 30 and the speaker 31 to be interconnected.

The storage unit 27 stores a plurality of software programs such as an application program for generating the encryption key, an application program for making the digital signature, and a web browser for obtaining necessary information and for sending necessary information by referring, via the open network 6, to services offered from the service provider terminal 2 or to data such as information on the cumulative total of the issued points.

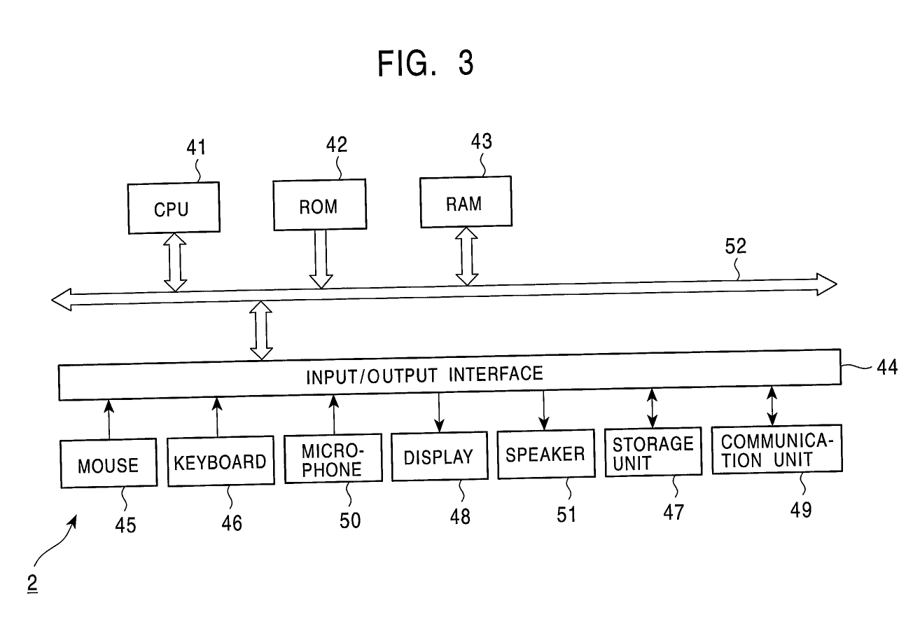

FIG. 3 shows a detailed construction of the service provider terminal 2. A CPU 41 and an internal bus 52 of the service provider terminal 2 are identical to the CPU 21 and the internal bus 32, respectively, shown in FIG. 2.

A storage unit 47 stores a plurality of software programs such as an application program for computing the charge for each customer, the cumulative total of the issued points, and the like, an application program for creating data to be distributed to customers, and an application program for distributing the data to the customers via the open network 6.

The storage unit 47 stores data corresponding to the content distributed to the customers. When access to the content is requested from the customer terminal 1, the CPU 41 reads the data corresponding to the requested data from the storage unit 47 and sends the data to the customer terminal 1 via an input/output interface 44, a communication unit 49, and the open network 6.

Alternatively, instead of storing the data in the storage unit 47, the data may be uploaded to and stored in a predetermined server (not shown) which is connected to the open network 6. In this case, when the customer uses the data, the customer terminal 1 accesses this server storing the data via the open network 6.

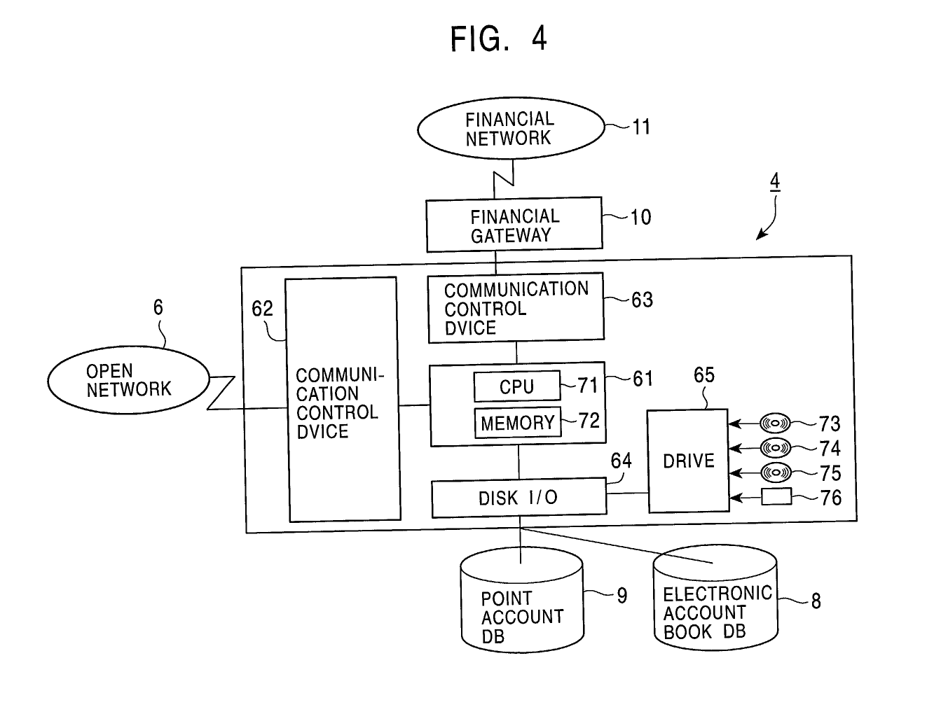

FIG. 4 shows a detailed construction of the point redemption system 4.

The point redemption system 4 includes a processor/storage device 61 having a CPU 71 and a memory 72, communication control devices 62 and 63, a disk I/O (input/output device) 64, and a drive 65. The CPU 71 reads and executes a program stored in the memory 72 in accordance with a signal received via the open network 6. For example, the CPU 71 sends a control signal via the communication control device 63 and the financial gateway 10 to a predetermined financial institution connected to the financial network 11, or accesses via the disk I/O 64 the electronic account book DB 8 or the point account DB 9 to retrieve necessary information or to update the contents of the accessed database with the latest information. The disk I/O 64 is connected to the drive 65 which serves to exchange data with a magnetic disk 73, an optical disk 74, a magneto-optical disk 75, a semiconductor memory 76, and the like.

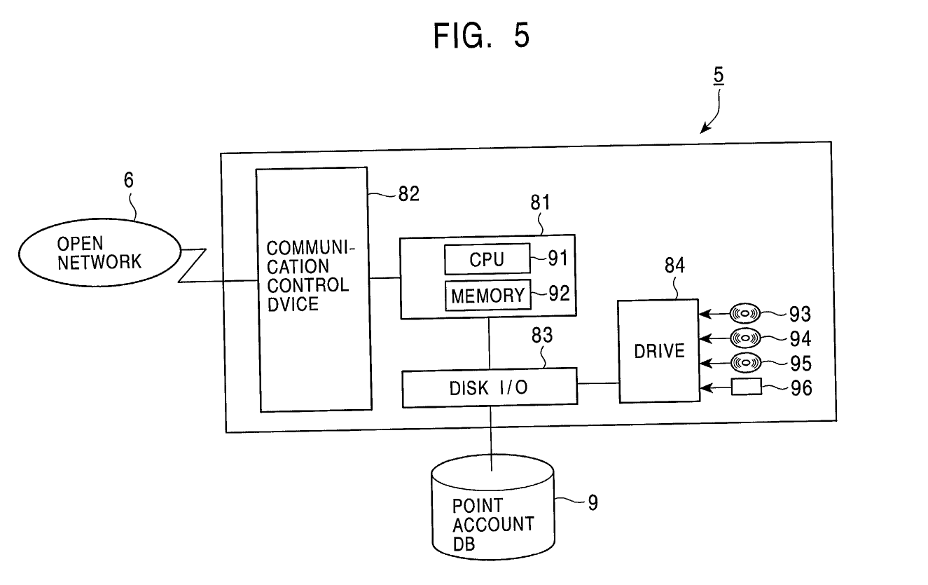

FIG. 5 shows a detailed construction of the point issuing system 5.

The point issuing system 5 includes a processor/storage device 81 having a CPU 91 and a memory 92, a communication control device 82, a disk I/O 83, and a drive 84. The CPU 91 reads and executes a program stored in the memory 92 in accordance with a signal received via the open network 6. For example, the CPU 91 accesses via the disk I/O 83 the point account DB 9 to retrieve necessary information or to update the contents of the accessed database with the latest information. The disk I/O 83 is connected to the drive 84 which serves to exchange data with a magnetic disk 93, an optical disk 94, a magneto-optical disk 95, a semiconductor memory 96, and the like.

As shown in FIGS. 4 and 5, the point redemption system 4 and the point issuing system 5 are described as systems constructed using a plurality of components. The features of the systems 4 and 5 may be each implemented as a single device by mounting a single component having corresponding features of the systems 4 and 5 in the single device. In addition, the systems 4 and 5 may contain the electronic account book DB 8 and the point account DB 9. Furthermore, the point redemption system 4, the point issuing system 5, the point account DB 9, and the electronic account book DB 8 may be integrated into a single device, so that the single device having equivalent features of the above-described systems and DBs may be realized.

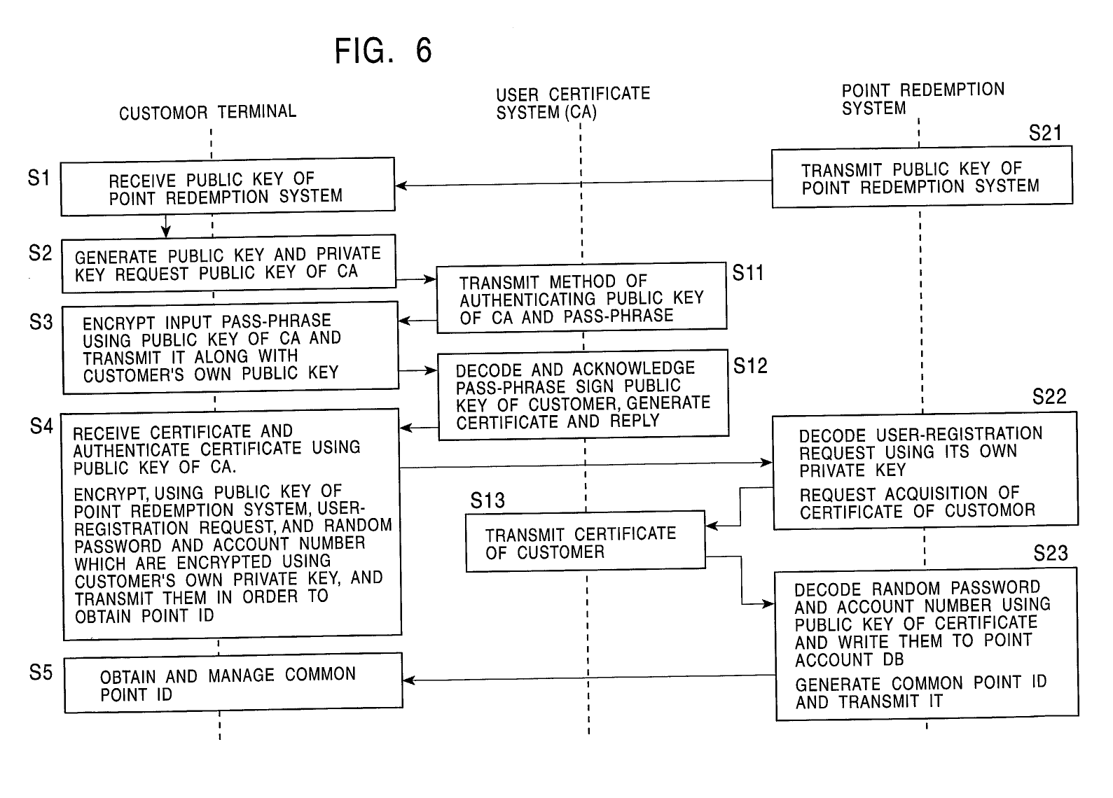

With reference to FIG. 6, processing is described in which the point redemption system 4 issues a common point ID to the customer.

At step S21, when the CPU 21 of the customer terminal 1 requests issue of the common point ID, the CPU 71 of the point redemption system 4 reads its own public key Kₚ₄ stored in the memory 72 and sends the public key Kₚ₄ to the customer terminal 1 via the communication control device 62 and the open network 6.

At step S1, the communication unit 29 of the customer terminal 1 receives the public key Kₚ₄ of the point redemption system 4, which is sent from the point redemption system 4 at step S21. The CPU 21 stores the received public key Kₚ₄ in the storage unit 27 via the input/output interface 24.

At step S2, the CPU 21 loads and executes the application program for generating the encryption key from the storage unit 27 to generate a public Kₚ₁ and a private key Kₛ₁. The CPU 21 generates a signal for requesting the user certificate system 3 to send a public key Kₚ₃ thereof and sends the signal to the user certificate system 3 via the internal bus 32, the input/output interface 24, the communication unit 29, and the open network 6.

At step S11, the user certificate system 3 sends its own public key Kₚ₃ and a pass phrase confirming method to the customer terminal 1 via the open network 6. For example, in order to confirm the pass phrase, the user certificate system 3 instructs the customer to send the pass phrase specified by the customer thereto by postal delivery or the like instead of sending it via the network. At step S12 described below, the user certificate system 3 authenticates the identification of the customer based on the matching result of the postal-delivered pass phrase and the decoded pass phrase, encrypted using the public key Kₚ₃, which is sent from the customer terminal 1 at step S3 described below.

At step S3, the CPU 21 of the customer terminal 1 encrypts the pass phrase input by the customer using the public key Kₚ₃ of the user certificate system 3, which is sent from the user certificate system 3 at step S11. The CPU 21 sends this encrypted pass phrase along with its own public key Kₚ₁, which is generated at step S2, to the user certificate system 3 via the internal bus 32, the input/output interface 24, the communication unit 29, and the open network 6.

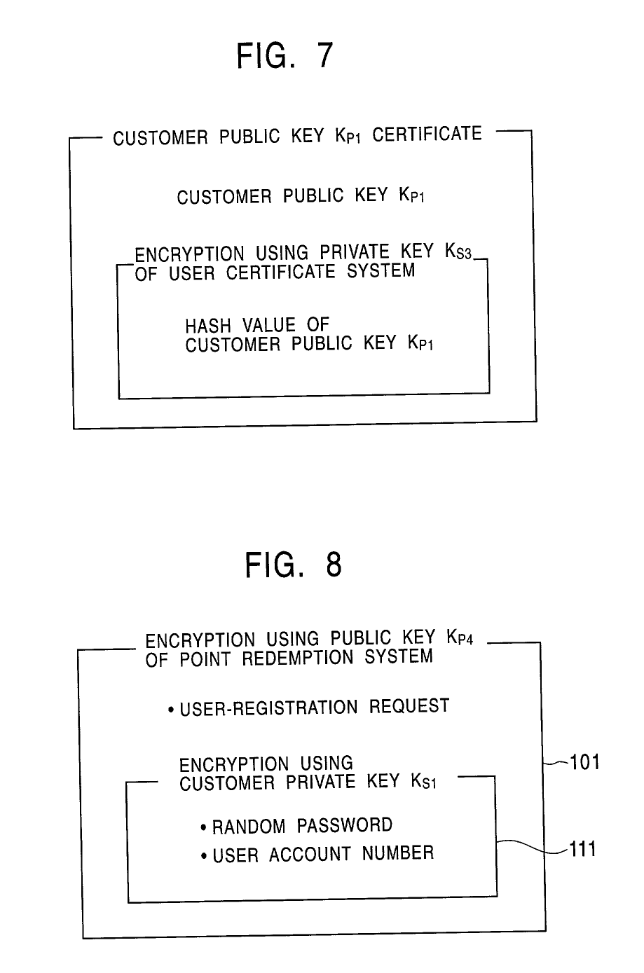

At step S12, the user certificate system 3 receives the data encrypted using the public key Kₚ₃ thereof, which is sent from the customer terminal 1 at step S3. The received data is decoded into the pass phrase using a private key Kₚ₃ thereof and then the pass phrase is confirmed. As a result of the confirmation, when the data is confirmed to be sent from the authenticated customer, a certificate is generated by signing the public key Kₚ₁ of the customer using the private key Kₛ₃ of the user certificate system 3, which means that the hash value of the public key Kₚ₁ is encrypted using the private key Kₛ₃ and is attached to the certificate. The user certificate system 3 sends the certificate to the customer terminal 1 via the open network 6 while allowing the user certificate DB 7 to store information on the authenticated customer. FIG. 7 shows the certificate issued by the user certificate system 3.

At step S4, the communication unit 29 of the customer terminal 1 receives the certificate, which is sent from the user certificate system 3 at step S12. The received certificate is input to the CPU 21 via the input/output interface 24 and the internal bus 32. The CPU 21 decodes the certificate using the public key Kₚ₃ of the user certificate system 3 and confirms the authentication of the certificate with respect to its own public key Kₚ₁. Using the public key Kₚ₄ of the point redemption system 4, the CPU 21 encrypts a user registration request, and a random password and an account number of the customer which are encrypted using the private key Kₛ₁ of the customer. These encrypted data are sent to the point redemption system 4.

FIG. 8 shows this transmission data 101. The user registration request can be decoded using the private key Kₛ₄ of the point redemption system 4. However, without the public key Kₚ₁ of the customer, data 111 including the random password and the account number cannot be decoded.

At step S22, the communication control device 62 of the point redemption system 4 receives the data 101, which is sent from the customer terminal 1 at step S4. The data 101 is input to the CPU 71 in which its own private key Kₛ₄ is read from the memory 72 and the input data 101 is decoded using it. However, since the data 111 is encrypted using the private key Kₛ₁ of the customer, it cannot be decoded at this moment. The CPU 71 confirms the user registration request, generates a signal for requesting the certificate of the customer to the user certificate system 3, and sends the signal to the user certificate system 3 via the communication control device 62 and the open network 6.

At step S13, the user certificate system 3 receives the request of the certificate of the customer, which is sent from the point redemption system 4 at Step S22. The certificate of the corresponding customer is sent to the point redemption system 4 via the open network 6.

At step S23, the communication control device 62 of the point redemption system 4 receives the certificate which is sent from the user certificate system 3 at step S13. The certificate is input to the CPU 71. Using the public key Kₚ₁ of the customer included in the received certificate, the CPU 71 decodes the random password and the account number included in the still-encrypted data 111, which is included in the data 101 received at step S22. When necessary, the CPU 71 authenticates the customer account by querying the financial institution 13 having the customer account concerning the trade reference and the like via the communication control device 63, the financial gateway 10, and the financial network 11. The CPU 71 accesses via the disk I/O 64 the point account DB 9 to add a record having a description of the random password and the account number to the point account DB 9. The common point ID of this customer is generated and is encrypted using the public key Kₚ₁ of the customer. The encrypted common point ID is sent to the customer terminal 1 via the communication control device 62 and the open network 6.

At step S5, the communication unit 29 of the customer terminal 1 receives the common point ID which is sent from the point redemption system 4 at step S23. The common point ID is sent to the CPU 21 in which the common point ID is decoded using the private key Kₛ₁ read from the memory 72 and is stored in the memory 72. Finally, the processing for issuing the common point ID issuing processing is completed.

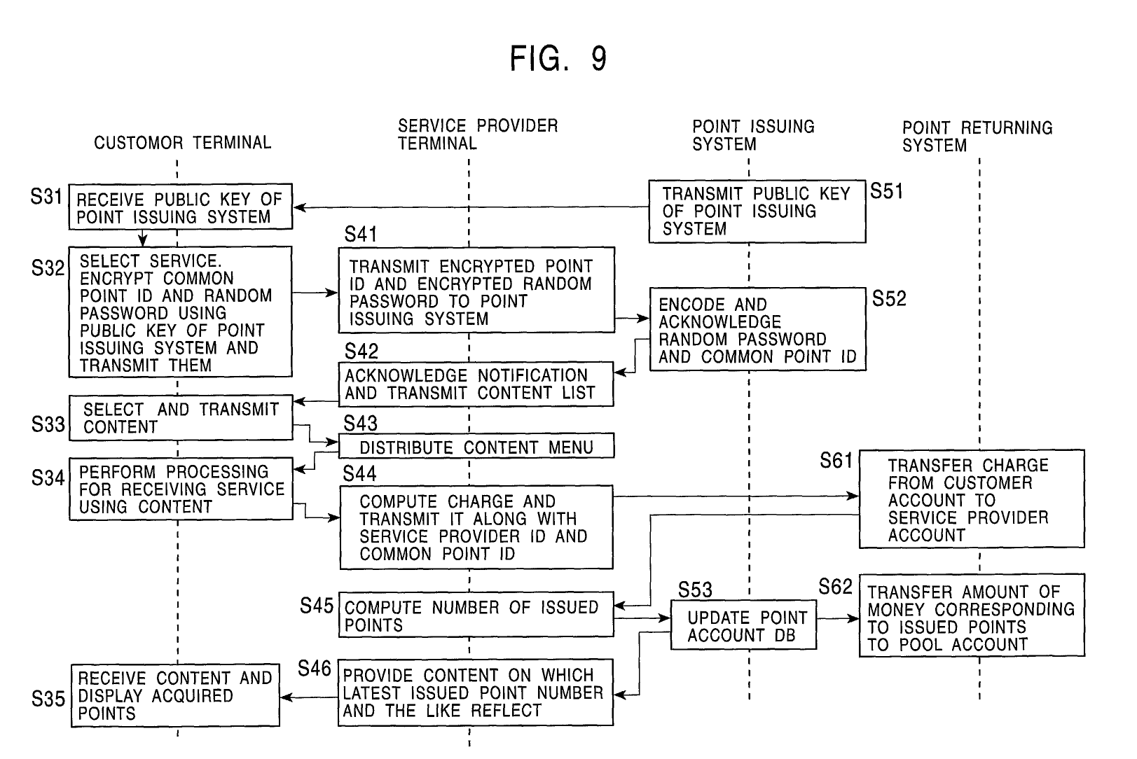

With reference to FIG. 9, accounting processing is described when the customer uses the service.

At step S51, when receiving a request from the CPU 21 of the customer terminal 1, the CPU 91 of the point issuing system 5 sends a public key Kₚ₅ of the point issuing system 5 stored in the memory 92 to the customer terminal 1 via the communication control device 82 and the open network 6.

At step S31, the communication unit 29 of the customer terminal 1 receives the public key Kₚ₅ which is sent from the point issuing system 5 at step S51. The CPU 21 of the customer terminal 1 stores the public key Kₚ₅ in the storage unit 27 via the input/output interface 24.

At step S32, the customer specifies his or her desired service (service provider) using the keyboard 26 or the mouse 25. A signal corresponding to the specified service is input to the CPU 21 via the input/output interface 24 and the internal bus 32. The CPU 21 generates data corresponding to an input screen for the common point ID and the random password, and causes the display 28 to show the input screen via the internal bus 32 and the input/output interface 24. The customer inputs the common point ID and the random password in accordance with instructions on the input screen. The signal corresponding to the input by the customer via the input/output interface 24 and the internal bus 32 is sent to the CPU 21 in which the input common point ID and the random password are encrypted using the public key Kₚ₅ of the point issuing system 5 read from the storage unit 27. These encrypted data are sent to the service provider 2 via the internal bus 32, the input/output interface 24, the communication unit 29, and the open network 6.

At step S41, the communication unit 49 of the service provider terminal 2 receives the common point ID and random password, encrypted using the public key Kₚ₅, which are sent from the customer terminal 1 at step S32. These encrypted common point ID and random password are input to the CPU 41 via the input/output interface 44 and the internal bus 52. The CPU 41 confirms the network address of the sender and the like (non-encrypted information) from the input signal. If necessary, these data are temporarily stored in the RAM 43 or the storage unit 47. The CPU 41 sends the received signal including the common point ID and the random password, which are encrypted using the public key Kₚ₅, to the point issuing system 5 via the internal bus 52, the input/output interface 44, the communication unit 49, and the open network 6.

At step S52, the communication control device 82 of the point issuing system 5 receives the common point ID and the random password, which are encrypted using the public key Kₚ₅. These received data are sent to the CPU 91 in which a private key Kₛ₅ of the point issuing system 5 is read from the memory 92 and the received signal is decoded using the private key Kₛ₅. The CPU 91 accesses the point account DB 9 to authenticate that the data sender is a registered customer by confirming the common point ID and the random password based on the data stored in the point account DB 9. The CPU 91 notifies the result of the authentication to the service provider terminal 2 via the communication control device 82 and the open network 6.

At step S42, the communication unit 49 of the service provider terminal 2 receives the notification of the result of the authentication, which is sent from the point issuing system 5 at step S52. The notification is input, via the input/output interface 44 and the internal bus 52, to the CPU 41 in which this notification is confirmed and data corresponding to a list of services available to the customer is generated. The generated data is sent to the customer terminal 1 via the internal bus 52, the input/output interface 44, the communication unit 49, and the open network 6.

At step S33, the communication unit 29 of the customer terminal 1 receives the data corresponding to the list of the available services. The CPU 21 causes the display 28 via the input/output interface 24 to show the received data. The customer selects a desired service by referring to a menu screen on the display 28. A signal corresponding to the customer's selection is input from the keyboard 26 or the mouse 25 to the CPU 21 via the input/output interface 24 and the internal bus 32. The CPU 21 sends the input signal corresponding to the customer's selection to the service provider terminal 2 via the internal bus 32, the input/output interface 24, the communication unit 29, and the open network 6.

At step S43, the communication unit 49 of the service provider terminal 2 receives the signal indicating the customer's selection, which is sent from the customer terminal 1 via the open network 6. The received signal is input via the input/output interface 44 and the internal bus 52 to the CPU 41 in which an item menu corresponding to the selected service is read based on the received signal from the storage unit 47 via the internal bus 52 and the input/output interface 44. The read item menu is distributed to the customer terminal 1 via the communication unit 49 and the open network 6.

At step S34, the communication unit 29 of the customer terminal 1 receives the item menu, which is distributed from the service provider terminal 2 at step S43. The CPU 21 causes the display 28 to show the received contents menu via the input/output interface 24. The customer looks through the item menu shown on the display 28 and, for example, purchases a product on an online shopping mall. The CPU 21 performs processing for a variety of services in accordance with a signal which is input, via the input/output interface 26 and the internal bus 32, by the customer using the keyboard 26, the mouse 25 or the like. The input signal is sent to the service provider terminal 2 via the internal bus 32, the input/output interface 24, the communication unit 29, and the open network 6.

At step S44, the communication unit 49 of the service provider terminal 2 receives the signal representing the operation of the customer, which is sent from the customer terminal 1. The received signal is input to the CPU 41 via the input/output interface 44 and the internal bus 52. The CPU 41 computes, based on the received signal, the charge to the customer for the service offered by the service provider in accordance with information concerning the product purchased at the online store, the quantity of the purchased products, the accessed period to an online game, and the like. The computed charge along with the service provider ID and the customer common point ID is sent to the point redemption system 4 via the internal bus 52, the input/output interface 44, the communication unit 49, and the open network 6. In this case, the service provider ID is a unique identification number that is given to the service provider when it joins this system.

At step S61, the CPU 71 of the point redemption system 4 generates a control signal for causing the account number of the customer and the account number of the service provider to be retrieved by querying the point account DB 9 based on the service provider ID and the customer common point ID, which are sent from the service provider terminal 2 at step S44, and for causing the computed charge to be transferred from the customer account to the service provider account. The control signal is sent to the financial gateway 10 via the communication control device 63. Since the financial gateway 10 has a transaction routing feature, it assigns a server via the financial network 11 to process each transaction which constitutes each of the operations corresponding to the input control signal, so that the assigned server performs the assigned transaction.

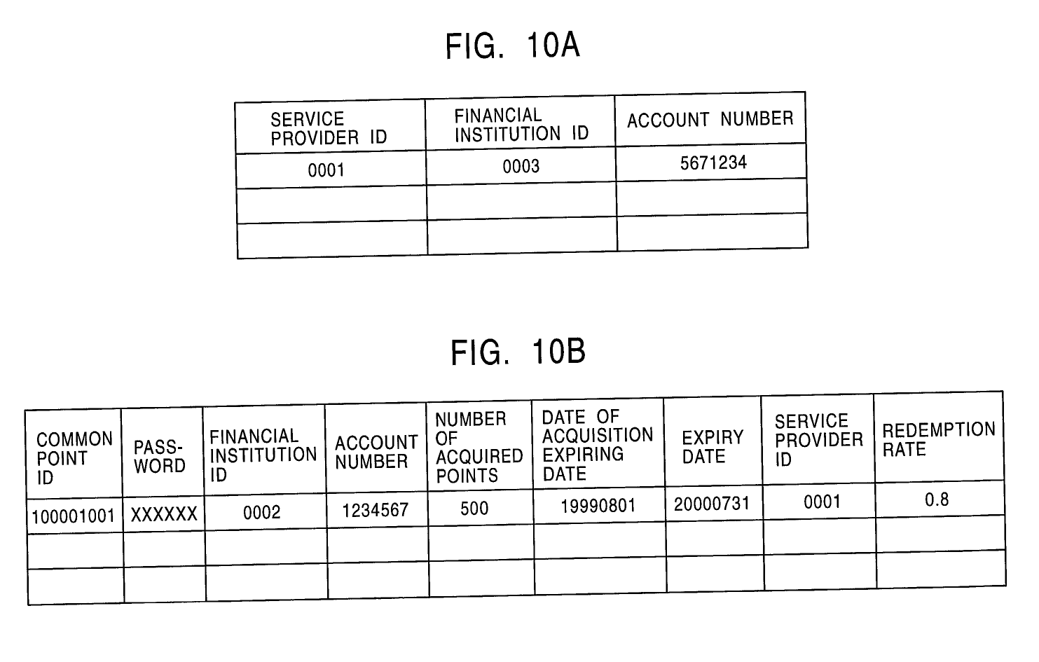

FIGS. 10A and 10B show example tables constructed in the point account DB 9. FIG. 10A shows the construction of a service provider table. The service provider table includes the service provider ID, the corresponding financial institution ID and the account number in the corresponding financial institution. FIG. 10B shows the construction of a point management table. The point management table includes information on customers (the common point ID, the password, the financial institution ID, and the account number in the corresponding financial institution), the number of collected points, the date of acquisition thereof, the expiry date thereof, the service provider ID of the service provider responsible for these points collected by the customer, and the redemption rate. For example, based on these two tables shown in FIGS. 10A and 10B, the point transfer dealer creates a query which includes the total of the issued points for each service provider, and the financial institution ID and the account number of the financial institution of the service provider. This created query allows the point transfer dealer to make a bill for each service provider.

At step S45, the CPU 41 of the service provider terminal 2 computes the issued points based on the charge to the customer, which is computed at step S44. The computation result of the issued points is sent to the point issuing system 5 via the internal bus 52, the input/output interface 44, the communication unit 49, and the open network 6.

At step S53, the communication control device 82 of the point issuing system 5 receives the computation result of the issued points, which is sent from the service provider terminal 2 at step S45. The computation result is input to the CPU 91. The CPU 91 accesses via the disk I/O 83 the point account DB 9 to update the point management table of the point account DB 9 based on the received result of the issued points. The CPU 91 sends the updated result to the service provider terminal 2 via the communication control device 82 and the open network 6 while sending a signal notifying the update of the point management table to the point redemption system 4.

At step S62, the communication control device 62 of the point redemption system 4 receives the signal notifying the update of the point management table. This signal is input to the CPU 71. At step S53, the CPU 71 accesses via the disk I/O 64 the point account DB 9 to generate a control signal for transferring an amount of money corresponding to the issued points to the pool account at the financial institution 15 based on the point management table updated by the point issuing system 5. The generated signal is sent to the server of the financial institution 14 having the point transfer dealer account via the communication control device 63, the financial gateway 10, and the financial network 11. This causes an amount of money corresponding to the issued points to be transferred from the point transfer dealer account to the pool account at the financial institution 15.

At step S46, the communication unit 49 of the service provider terminal 2 receives the update result of the point account DB 9 which is sent from the point issuing system 5 at step S53. The received update result is input to the CPU 41 via the input/output interface 44 and the internal bus 52. The CPU 41 generates the image data shown on the display 28 of the customer terminal 1 in which the latest number of the issued points and the like are reflected based on the received update result. The generated image data is provided to the customer terminal 1 via the internal bus 52, the input/output interface 44, the communication unit 49, and the open network 6.

At step S35, the communication unit 29 of the customer terminal 1 receives the generated image data, which is sent from the service provider terminal 2 at step S46. The CPU 21 outputs via the input/output interface 24 the received image data to the display 28 in which the collected points and the like are shown. Finally, processing for accounting is completed.

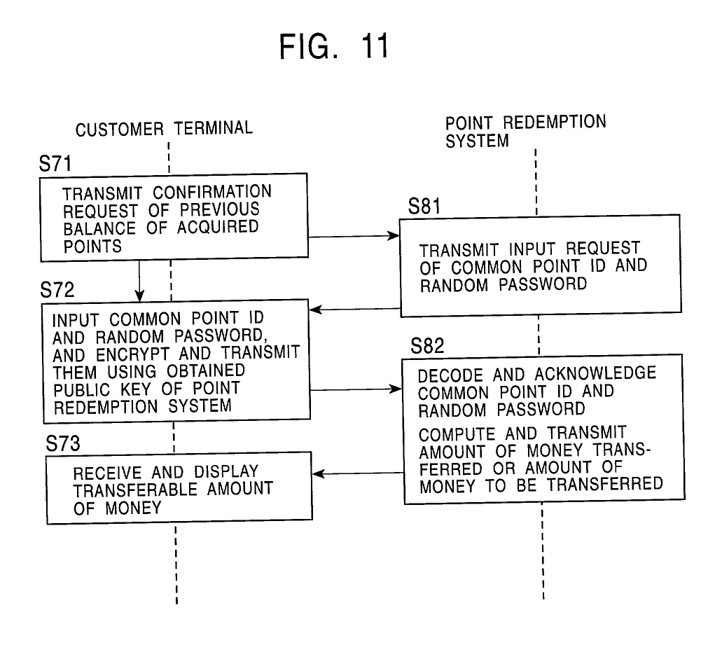

With reference to FIG. 11, processing for confirming the amount of money to be transferred by the customer is described.

At step S71, the CPU 21 of the customer terminal 1 generates a signal for requesting the balance of the collected points. The generated signal is sent to the point redemption system 4 via the internal bus 32, the input/output interface 24, the communication unit 29, and the open network 6.

At step S81, the communication control device 62 of the point redemption system 4 receives the generated signal, which is sent from the customer terminal 1 at step S71. The received signal is input to the CPU 71 in which a signal for requesting the common point ID input and the random password input is generated. The signal is sent to the customer terminal 1 via the communication control device 62 and the open network 6.

At step 72, the communication unit 29 of the customer terminal 1 receives the signal requesting input of the common point ID and the random password. The received signal is input to the CPU 21 via the input/output interface 24 and the internal bus 32. The CPU 21 generates data corresponding to an input screen for the common point ID and the random password. The display 28 shows the generated data via the internal interface 32 and the input/output interface 24. The customer examines the input screen, and enters the common point ID and the random password using the keyboard 26. A signal corresponding to the input common point ID and the input random password are input to the CPU 21 via the input/output interface 24 and the internal bus 32. The CPU 21 encrypts the signal using the public key Kₚ₄ of the point redemption system 4, which is received and stored in the storage unit 27 at step S1 in FIG. 6. The CPU 21 sends the encrypted signal to the point redemption system 4 via the internal bus 32, the input/output interface 24, the communication unit 29, and the open network 6.

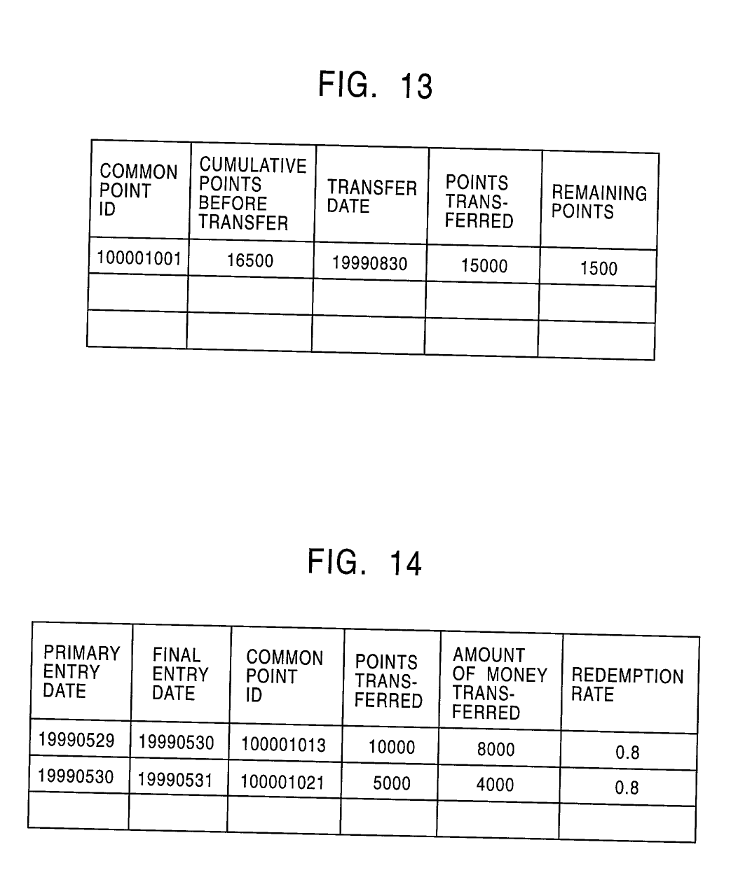

At step S82, the communication control device 62 of the point redemption system 4 receives the encrypted signal using the public key Kₚ₄, which is sent from the customer terminal 1 at step S72. The encrypted signal is input to the CPU 71 in which the received signal is decoded using the private key Kₛ₄ read from the memory 72, whereby the common point ID and the random password are confirmed. The CPU 71 accesses via the disk I/O 64 the point account DB 9 to compute money to be transferred corresponding to the customer based on the point management table, a cumulative total point table in the point account table DB 9 in shown in FIG. 13, and a point transfer table in the electronic account book DB 8 shown in FIG. 14. The computation result is sent to the customer terminal 1 via the communication control device 62 and the open network 6.

At step S73, the communication unit 29 of the customer terminal 1 receives the computation result of the amount of money to be transferred, which is computed in the point redemption system 4 at step S82. The computation result is input to the CPU 21 in which data corresponding to a screen for displaying the amount of money to be transferred is generated based on the computation result. The generated data causes the display 28 to show the amount of money to be transferred. Finally, processing for confirming is completed.

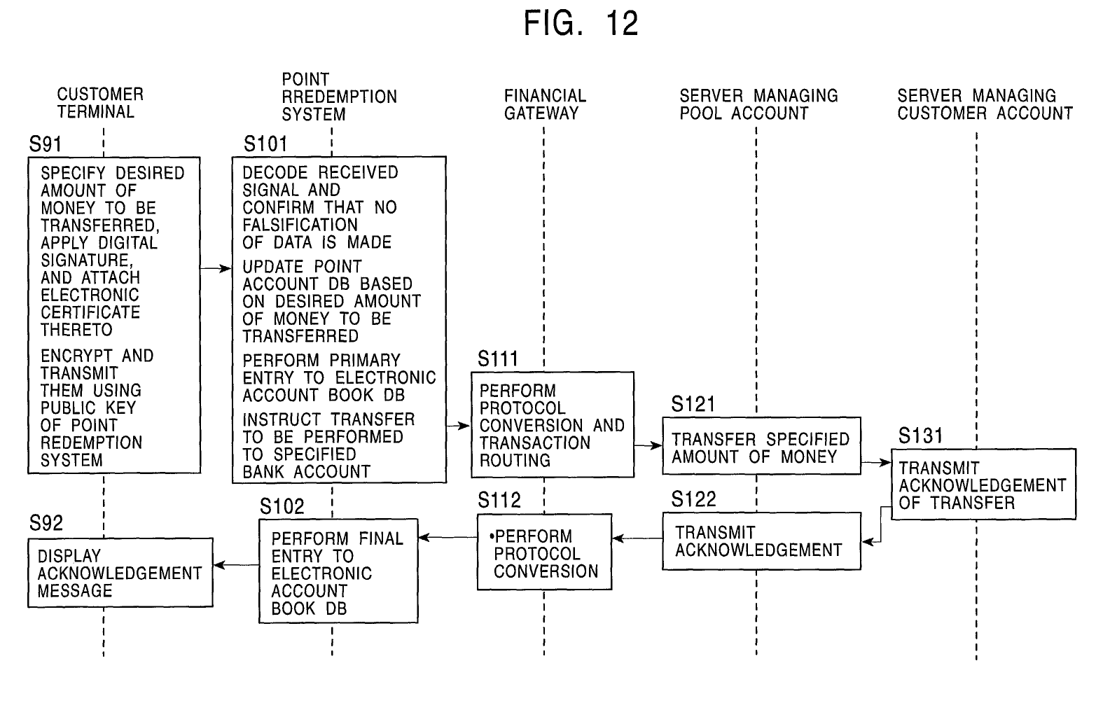

With reference to the flowchart in FIG. 12, processing is described in which the customer receives online redemption by transferring points.

At step S91, the customer inputs a desired amount of transfer money using the keyboard 26. The signal corresponding to the input by the customer is input to the CPU 21. The CPU 21 computes the hash value of the desired amount of transfer money to perform the signature using its own private key Kₛ₁. In addition, the CPU 21 reads, from the storage unit 27, the public key Kₚ₄ of the point redemption system 4, which is received and stored in the storage unit 27 at step S1 in FIG. 6, and encrypts using the read public key Kₚ₄ the desired amount of transfer money, its own digital signature, and the certificate issued from the user certificate system 3. The encrypted data is sent to the point redemption system 4 via the internal bus 32, the input/output interface 24, the communication unit 29, and the open network 6.

At step S101, the communication control device 62 of the point redemption system 4 receives the encrypted data, which is sent from the customer terminal 1 at step S91. The encrypted data is input to the CPU 71 in which the received data is decoded using its own private key Kₛ₄ read from the memory 72 and the presence of falsification of the decoded data is confirmed.

When it is confirmed that no falsification is made to the data which is sent from the customer, the CPU 71 accesses via the disk I/O 64 the point account DB 9 to, for example, update the cumulative total point table having, as shown in FIG. 13, the customer common point ID, the balance of the points, the transfer date, the number of the transfer points, and the number of the remaining points. For example, in FIG. 13, since the customer having a common point ID of 100001001 transfers 15000 points out of 16500 points on Aug. 8, 1999, the cumulative total point table is updated so that the number of the current remaining points is 1500 points.

The CPU 71 accesses via the disk I/O 64 the electronic account book DB 8 to primarily enter necessary data in the point transfer table, as shown in FIG. 14, having the primary entry date, the final entry date, the common point ID, the number of the transfer points, the amount of transfer money, and the redemption rate. For example, FIG. 14 indicates that the customer having a common point ID of 100001013 gets the amount of transfer money of 8000 yen by transferring 10000 points by a redemption rate of 80 percent. The redemption rate may be raised or lowered during the limited period of time. Alternatively, the redemption rate may be raised when points are desired to be redeemed for other than cash. At this point, the final entry date is not entered.

After the above processing, the CPU 71 generates a control signal which allows a desired amount of transfer money to be transferred to a specified account. The generated signal is sent to the financial gateway 10 via the communication control device 63.

At step S111, the financial gateway 10 performs protocol conversion and transaction routing on the signal, which is sent from the point redemption system 4 at step S101. Since the financial gateway 10 has the transaction routing feature, it assigns a server, via the financial network 11, to process each transaction which constitutes each of the operations corresponding to the input control signal, so that the assigned server performs the assigned transaction.

At step S121, the server of the financial institution 15 having the pool account transfers the desired amount of money to the customer account at the financial institution 13 in accordance with the control signal sent via the financial network 11. At step S131, the server of the financial institution 13 having the customer account receives a predetermined amount of money, which is transferred from the pool account at the financial institution 15 at step S121. The transfer result is sent to the server of the financial institution 15 having the pool account.

At step S122, the server of the financial institution 15 having the pool account confirms the transfer result, which is sent from the server of the financial institution 13 having the customer account at step S131. The acknowledgement signal is sent via the financial network 11 to the financial gateway 10 in order to be sent to the point redemption system 4.

At step S112, the financial gateway 10 performs protocol conversion on the signal, which is on its way to the point redemption system 4 from the server of the financial institution 15 having the pool account. The converted signal is sent to the point redemption system 4.

At step S102, the communication control device 63 of the point redemption system 4 receives the acknowledgement signal, which is sent from the server of the financial institution 15 having the pool account at step S122 and which is protocol-converted by the financial gateway 10 at step S112. The acknowledgement signal is input to the CPU 71 which confirms whether the point transfer is appropriately executed. In addition, the CPU 71 accesses via the disk I/O 64 the electronic account book DB 8 to perform final entry on the point transfer table as shown in FIG. 14. This means that the final entry date field, which is not updated at step S101, is updated. Finally, the CPU 71 sends a signal representing completion of the transfer processing to the customer terminal 1 via the communication control device 62 and the open network 6.

At step S92, the communication unit 29 of the customer terminal 1 receives the signal representing completion of the transfer processing, which is sent from the point redemption system 4 at step S102. This signal is input to the CPU 21 via the input/output interface 24 and the internal bus 32. The CPU 21 generates, based on the input signal, data corresponding to confirmation screen for completion of transfer processing and causes the display 28 to show, via the internal bus 32 and the input/output interface 24, the generated data. Finally, the transfer processing is completed.

The above-described sequence of processing may be implemented not only by hardware but also by software. When the sequence of processing is carried out by software, a computer in which a customized hardware has a program that constitute the software incorporated therein (for example, the CPU 71 in FIG. 4 or the CPU 91 in FIG. 91) may be used. Alternatively, a general-purpose personal computer which has a program constituting the software installed therein may be used.

A storage medium for storing the program is independent of the computer and is distributed for providing the program to users. As shown in FIG. 4 and FIG. 5, the storage medium for storing the program is constituted by package media including the magnetic disks 73 and 93 (including a floppy disk), the optical disks 74 and 94 (including CD-ROM (Compact Disk-Read Only Memory) or DVD (Digital Versatile Disk)), the magneto-optical disks 75 and 95 (including MD (Mini-Disk)), and the semiconductor memories 76 and 96. Alternatively, it may be constituted by the storage medium for storing the program, such as the memory 92 of the processor/storage device 81 or the like which are preinstalled in the customized hardware and then provided to users.

In the present embodiment, the steps which constitute the program stored in the storage medium are not necessarily sequentially executed in accordance with the described order. Some of them may be executed in parallel or may be separately executed.

In the present embodiment, the system means an overall apparatus that is constituted by a plurality of devices.

What is claimed is:

1. An information processing apparatus for processing information concerning electronic commerce in which a customer receiving services offered by a service provider obtains points in accordance with the amount of money having been paid to said service provider, said information processing apparatus comprising:
first communication controlling means for controlling data communication with another information processing apparatus via a first network;
first recording means for recording information on a plurality of the service providers and information on a plurality of the customers receiving services from said plurality of service providers;
second communication controlling means for controlling data communication with a financial institution information processing apparatus via a second network;
payment computing means for computing an amount of money to be refunded to said customer in accordance with the number of the points said customer owns; and
signal generating means for generating a signal that requests said financial institution information processing apparatus having an account of said customer to transfer a predetermined amount of money to the account of said customer, wherein:
said first communication controlling means controls communication in which a signal corresponding to the amount of money computed by said payment computing means is sent to an information processing apparatus owned by said customer and a signal corresponding to a desired amount of transfer money is received from the information processing apparatus owned by said customer; and
said second communication controlling means controls communication in which the signal generated by said signal generating means is sent to said financial institution information processing apparatus and a signal representing completion of processing by said financial institution information processing apparatus is received.

2. An information processing apparatus according to claim 1, further comprising:
point computing means for computing the number of points of a predetermined customer from among said plurality of customers in accordance with a signal received from an information processing apparatus of said service provider under the control of said first communication controlling means;
a second recording means for recording the points owned by each of said plurality of customers, wherein said second recording means subtracts, from the currently recorded points of said customer, the points corresponding to an amount of money to be transferred which is not more than the amount of money computed by said payment computing means and which is desired by said customer after the signal representing completion of the processing is received under the control of said second communication controlling means.

3. An information processing apparatus according to claim 1, further comprising key generating means for generating an encryption key for encrypting and decoding communication data.

4. An information processing apparatus according to claim 1, further comprising authenticating means for authenticating said other information processing apparatus with which communication is controlled by said first communication controlling means.

5. An information processing apparatus according to claim 1, wherein said authenticating means authenticates said other information processing apparatus based on a certificate thereof which is received under the control of said first communication controlling means and which is issued from a predetermined certificate authority connected to said first network.

6. An information processing method for processing information concerning electronic commerce in which a customer receiving services offered by a service provider obtains points in accordance with the amount of money having been paid to said service provider, said information processing method comprising:
a first communication controlling step for controlling data communication with another information processing apparatus via a first network;
a recording step for recording information on a plurality of the service providers and information on a plurality of the customers receiving services from said plurality of service providers;
a second communication controlling step for controlling data communication with a financial institution information processing apparatus via a second network;
a payment computing step for computing an amount of money redeeming by said customer in accordance with the number of the points said customer owns; and
a signal generating step for generating a signal that requests said financial institution information processing apparatus having an account of said customer to transfer a predetermined amount of money to the account of said customer, wherein:
said first communication controlling step controls communication in which a signal corresponding to the amount of money computed in said payment computing step is sent to an information processing apparatus owned by said customer and a signal corresponding to a desired amount of transfer money is received from the information processing apparatus owned by said customer; and
said second communication controlling step controls communication in which the signal generated in said signal generating step is sent to said financial institution information processing apparatus and a signal representing completion of processing in said financial institution information processing apparatus is received.

7. A point redemption system for redeeming points owned by a customer for money, said point redemption system comprising:
receiving means for receiving a point redemption request for redeeming points owned by said customer for money, said point redemption request including information on the number of points which is desired to be redeemed for money from among the total points owned by said customer;
transferring means for transferring, to an account of said customer, an amount of money corresponding to the desired number of points in the information included in said point redemption request from among the total points; and
updating means for updating the total points corresponding to said customer by subtracting the desired number of points in the information included in said point redemption request from the total points owned by said customer.

8. A point redemption method for redeeming points owned by a customer for money, said point redemption method comprising:
a receiving step for receiving a point redemption request for redeeming points owned by said customer for money, said point redemption request including information on the number of points which is desired to be redeemed for money from among the total points owned by said customer;
a transferring step for transferring, to an account of said customer, an amount of money corresponding to the desired number of points in the information included in said point redemption request from among the total points; and
an updating step for updating the total points corresponding to said customer by subtracting the desired number of points in the information included in said point redemption request from the total points owned by said customer.
